(19) United States
(12) Patent Application Publication
(10) Pub. No.: US 2007/0262760 A1
(43) Pub. Date: Nov. 15, 2007

(54) MULTIPLE-OUTPUT DC-DC CONVERTER

(76) Inventor: Kwang-Hwa Liu, Sunnyvale, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,802

(22) Filed: May 9, 2006

(51) Int. Cl. G05F 1/00

(52) U.S. Cl. 323/282

(57) ABSTRACT

Disclosed is a single-inductor DC-DC converter capable of delivering a multiple output voltages. One of the output voltages is always higher than the input voltage, while other output voltages may by higher or lower than the input voltage. The DC-DC converter requires no input power switch connected between the input voltage source and the power inductor. The DC-DC converter delivers power to all output voltages during the same switching cycle. The highest output voltage is used to reset the inductor current.

### BACKGROUND OF THE INVENTION

1. Field of Invention

The present invention relates to a multiple-output DC-DC converter. More particularly, the present invention relates to a multiple-output, single-inductor boost DC-DC converter.

2. Description of Related Art

A voltage regulator (converter) is provided for taking an input voltage and providing a multiple of outputs of different voltage values. In general, a DC to DC voltage regulator may be used to convert a DC input voltage to either a higher or a lower DC output voltage. DC to DC converters with step-up/step-down characteristics are often required in applications where the input voltage and the output voltage requirements are incompatible. Many electronic systems require multiple output voltages from a single power source Vin. Vin may change over a wide range. For example, in an electronic system using 4 cells of alkaline battery connected in series, the battery pack voltage may drop from 6.6V, with new cells, to 3.6V when the battery is almost fully discharged. Further, one output Vo1 requires a constant 5V while another output Vo2 requires a constant 15V. For Vo1, the converter circuit needs to lower the input voltage when the input voltage is higher than 5V, but the converter need to raise the input voltage if the input voltage becomes lower than 5V.

FIG. 1 and FIG. 2 illustrate some commonly-used converters. In FIG. 1A˜FIG. 1C and FIG. 2, Vin, Q1/Q2, D1/D2, L1/L2, C0/C1, RL and Vout refer to the input voltage, transistors, diodes, inductors, capacitors, a load resistor and the output voltage. FIG. 1A illustrates a conventional buck converter which can only reduce an input voltage (Vin) to an output voltage, Vo=Vin*D, in continuous current mode of operation, where D refers to a PWM (pulse width modulation) duty cycle. FIG. 1B illustrates a conventional boost converter which can only increase an input voltage (Vin) to an output voltage, Vo=Vin/(1−D), in continuous current mode of operation. FIG. 1C illustrates a conventional SEPIC converter which can raise or lower an input voltage (Vin) to an output voltage V0=Vin*D/(1−D) in continuous current mode. However, the SEPIC converter requires two inductors (L1 and L2) and one additional blocking capacitor (C1). Its efficiency is generally lower than the buck or the boost converter. FIG. 1D illustrates voltage conversion ratio of the three abovementioned converters.

One approach to achieve the voltage step up/down capability is to use a π-bridge buck-boost converter, as shown in FIG. 2. In the buck operation mode, the transistor Q1 and the diode D1 are constantly switching while the transistor Q2 is always off and the diode D2 is always on. In the boost operation mode, the transistor Q2 and the diode D2 are constantly switching while the transistor Q1 is always on and the diode D1 is always off. In essence, the π-bridge buck-boost converter is a combinatory configuration of a buck converter and a boost converter, operating in either a buck (step-down) mode or a boost (step-up) mode.

The π-bridge buck-boost converter requires two transistors and two diodes. Circuit topology is complicated and efficiency is low due to the extra rectifier loss on D1 and D2. For the π-bridge buck-boost converter, a sophisticated control circuit is required in order to regulate a stable output voltage over a wide range of input voltage.

Further, portable electronic applications typically require small but high-efficiency power converters. Oftentimes, such applications also require the power converters provide multiple outputs. To date, however, multiple-output power converters typically require multiple inductors or multiple transformer windings, one for each output, wherein each inductor or transformer winding utilizes a relatively large amount of circuit area. A conflict is thus presented in providing multiple-output power converters which are small in size.

There is a need for a multiple output DC-DC converter having the ability to provide two or more output voltages from one input voltage and use only one inductor.

### SUMMARY OF THE INVENTION

One of the aspects of the invention is to provide a simple, high efficiency DC-DC converter to deliver multiple output voltages. One output voltage is higher than the input voltage, while other output voltages may require step-up conversions when the input voltage is relatively low or step-down conversions when the input voltage is relatively high.

One of the aspects of the invention is to provide a DC-DC regulator with minimum number of inductors, transistors and diodes.

One of the aspects of the invention is to provide a DC-DC converter with easy control and high efficiency.

To achieve the above and other aspects, one embodiment of the invention provides a power converter using a single inductor for providing multiple power outputs at least including a first output and a second output. The second output is higher than both the first output and a power source. The power converter includes: a main power switch for regulating the inductor current; a first switch for regulating the inductor current flow to the first output; a reference voltage; a first control loop, generating a first error signal in response to the first output and the reference voltage; a second control loop, generating a second error signal in response to the second output and the reference voltage; and a control logic, for controlling the operation states of the main power switch and the first switch in response to the first and second error signals. The second output does not require a switch and the power converter delivers power to the first and second outputs during the same switching cycle.

Another embodiment of the invention provides a method of charging a plurality of loads during the same switching cycle using a single inductor. The inductor is energized. Power energized in the inductor is sequentially delivered to a first one of the loads and not to any other loads, and further sequentially delivered power to a second one of the loads and not to any other loads. A last power-delivered load is used to reset the inductor current within the same switching cycle.

Still another embodiment of the invention provides a voltage regulation system for providing output boost regulation for two loads in a same switching cycle. The voltage regulation system includes: a power source; an inductor, having a first terminal electrically connected to the power source and a second terminal; a main power switch, having an input terminal electrically connected to the second terminal of the inductor, an output terminal and a gate terminal; a first switch, having an input terminal electrically connected to the second terminal of the inductor, an output terminal and a gate terminal; a first rectifier, having an input terminal electrically connected to the output terminal of the first switch and an output terminal for connecting to a first load; a second rectifier, having an input terminal electrically connected to the second terminal of the inductor and an output terminal for connecting to a second load; and voltage feedback loops and control logic, modulating the conduction duty cycle of the main power switch and the first switch based on voltages on the second load and the first load respectively. The second load, whose voltage resets the inductor current, does not require a series switch.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A˜1D illustrate conventional converters and voltage transfer ratio thereof.

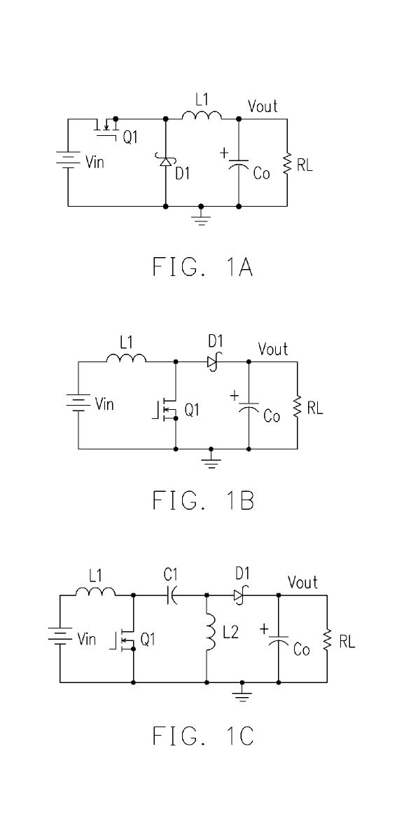

FIG. 2 illustrates a conventional π-bridge buck-boost converter.

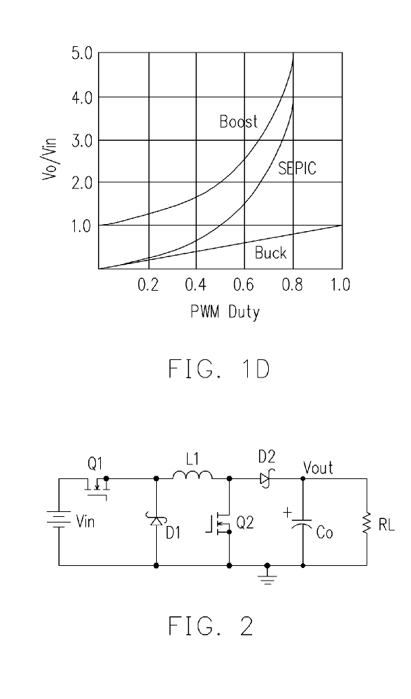

FIG. 3 illustrates a block diagram of a multiple-output DC-DC converter according to a first embodiment of the present invention.

FIGS. 4A˜4C illustrate timing and waveform diagrams of the embodiment when Vin=5V, Vin=4V, and Vin=6.6V are respectively demonstrated.

FIG. 5 illustrates a block diagram of a multiple-output DC-DC converter according to a second embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The multiple-output boost DC-DC converter has the ability to deliver a step up/down output as long as there is step-up output to reset the inductor current. Further, the power delivered to the first output, from light load to heavy load, is completely under the control of its regulation loop.

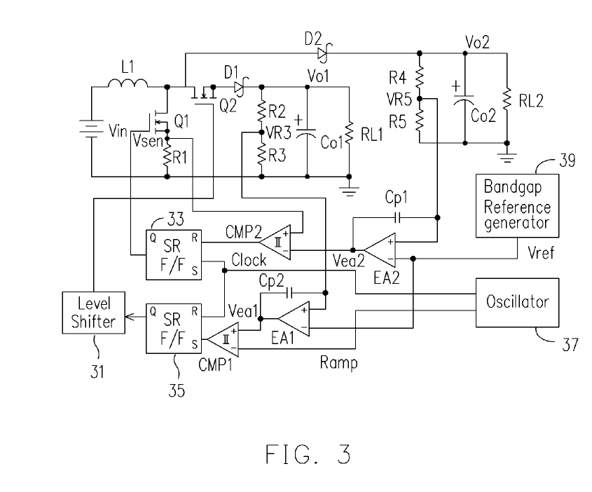

FIG. 3 illustrates a block diagram of a multiple-output DC-DC converter according to a first embodiment of the present invention. The multiple-output DC-DC converter is used for taking in a power source Vin and providing two output voltages Vo1 and Vo2. The converter includes an inductor L1, power switches Q1 and Q2, diodes D1 and D2, voltage dividers R2-R3 and R4-R5, output capacitors Co1 and Co2, compensation capacitors Cp1 and Cp2, loads (load resistors) RL1 and RL2, a level shifter 31, gate drivers, voltage feedback loops and control logic. Vin may be varied in a wide range, for example, from 6.6V to 3.6V. Vo2 is always higher than Vin, but Vo1 may be lower or higher than Vin.

A first terminal of the inductor L1 is coupled to the power source Vin and a second terminal of the inductor L1 is coupled to first terminals (drain terminals) of the power switches Q1 and Q2 and to an anode terminal of the diode D2. The main power switch Q1 has an input terminal coupled to the inductor, an output terminal coupled to a first terminal of a sense resistor R1 and a gate terminal coupled to the gate driver. The sense resistor R1 has a second terminal tied to ground. The sense resistor R1 senses the current flowing through the power switch Q1.

The power switch Q2 has an input terminal coupled to the inductor, a gate terminal coupled to the gate driver and an output terminal coupled to the anode terminal of the diode D1. The cathode terminal of the diode D1 is coupled to a first terminal of the voltage-divider R2-R3, to the output capacitor Co1 and to the load RL1. The voltage-divider resistors R2 and R3 are serially connected and another terminal of R3 is tied to ground. Another terminal of the output capacitor Co1 is also tied to ground. The load RL1 is coupled across the output capacitor Co1. The output capacitor Co1 is required to reduce the voltage ripple on load RL1.

The cathode terminal of the diode D2 is coupled to a first terminal of the voltage-divider R4-R5, to the output capacitor Co2 and to the load RL2. The voltage-divider resistors R4 and R5 are serially connected and another terminal of R5 is tied to ground. Another terminal of the output capacitor Co2 is also tied to ground. The load RL2 is coupled across the output capacitor Co2. The output capacitor Co2 is required to reduce the voltage ripple on load RL2.

The gate driver includes two flip-flops 33 and 35. The set input terminal S of the flip-flop 33 receives a clock signal CK generated from an oscillator 37. The reset input terminal R of the flip-flop 33 receives an output signal from a comparator CMP2. The output terminal Q of the flip-flop 33 is coupled to the gate terminal of the power switch Q1 for controlling ON/OFF states of Q1. The set input terminal S of the flip-flop 35 also receives the clock signal CK generated from the oscillator 37. The reset input terminal R of the flip-flop 35 receives an output signal from a comparator CMP1. The output terminal Q of the flip-flop 35 controls ON/OFF states of the power switch Q2 via the level shifter 31. The configuration of the level shifter 31 is not specially limited.

The oscillator 37 generates the clock signal CK with a frequency of, for example but not limited by, 1 MHz to the flip-flops 33 and 35. The oscillator 37 also generates a reference triangular wave Ramp to the comparator CMP1.

The bandgap reference voltage generator 39 generates a reference voltage Vref to the error amplifiers EA1 and EA2. A proportion of Vo1, VR3, is derived via the voltage divider R2-R3, where VR3=Vo1*R3/(R2+R3). A proportion of Vo2, VR5, is derived via the voltage divider R4-R5, where VR5=Vo2*R5/(R4+R5). The error amplifier EA1 has a positive input terminal receiving Vref and a negative input terminal coupled to VR3. The output of the error amplifier EA1, Vea1, modulates the on-time (conduction) time of the power switch Q2. In other words, EA1 regulates the power flowing into Vo1. The error amplifier EA2 has a positive input terminal receiving Vref and a negative input terminal coupled to VR5. The output of the error amplifier EA2, Vea2, modulates the on-time (conduction) time of the power switch Q1. In other words, EA2 indirectly regulates the power flowing into Vo2. The oscillator 37 outputs the clock signal CK to the flip-flops 33 and 35 for turning on the power switches Q1 and Q2.

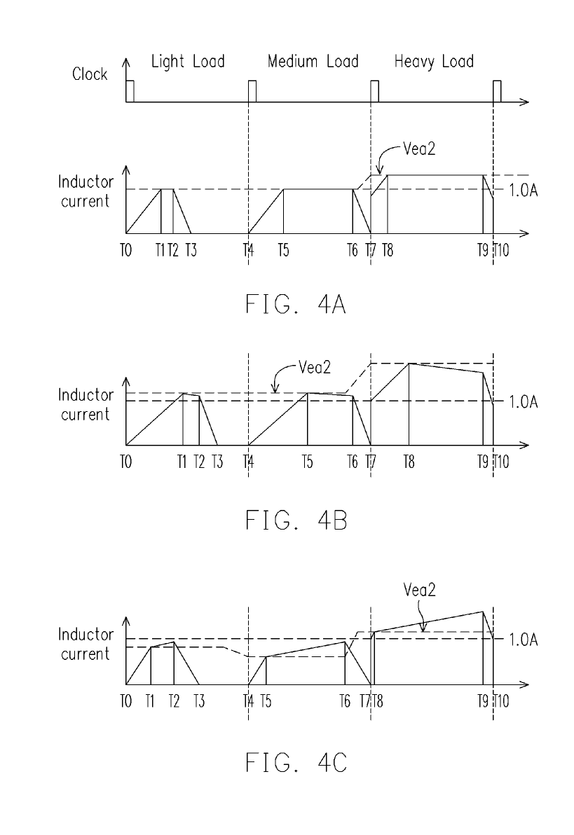

Please refer to both FIGS. 3 and 4A˜4C for better understanding of the operations of the multiple-output DC-DC converter. For simplicity of discussion, it is assumed that Vo2 (15V) has a constant load current of 75 mA. In FIG. 4, the inductor current waveforms are shown under different load conditions for Vo1. FIGS. 4A˜4C illustrate current waveform diagrams when Vin=5V, Vin=4V and Vin=6.6V are respectively demonstrated.

As shown in FIG. 4A, in the first switching cycle (light load switching cycle), from T0˜T4, Vo1 has a light load; in the second switching cycle (medium load switching cycle), from T4˜T7, Vo1 has a medium load and the inductor current is bordering on continuous current mode; and in the third switching cycle (heavy load switching cycle), from T7˜T10, Vo1 has a heavy load and the inductor current is in a continuous current mode.

FIG. 4A illustrates the inductor current waveform at three switching cycles. Vin, Vo1 and Vo2 are 5V, 5V and 15V, respectively. At the beginning of each switching cycle, i.e., T0, T4 and T7, Q1 and Q2 are both turned on. The oscillator 37 outputs the clock signal CK to the set input terminals S of the flip-flops 33 and 35 for turning on Q1 and Q2. The inductor increases at a rate of Vin/L1. When the inductor current reaches the level set by Vea2 (at T1), Q1 is turned off while Q2 keeps ON.

After Q1 is ON, the inductor current flows into the power switch Q1 and then to ground via the resistor R1. Because a current flows through the resistor R1, a voltage Vsen is occurred. Since voltage VR5 is coupled to the negative input of the error amplifier EA2, it outputs an error voltage Vea2 in response to the difference between VR5 and Vref. On the other hand, the comparator CMP2 outputs a pulse for resetting the flip-flop 33 when Vsen rises above the Vea2 level. So, a logic low signal from the output terminal of the flip-flop 33 shuts down the power switch Q1. Basically, the control loop responds to the status of VR5. If VR5 is lower than Vref, then Vea2 increases, thus allowing longer duty cycle of Q1.

After T1, the inductor current flows into Vo1 via Q2 and D1. Since Vin=Vo1=5V, the inductor current remains constant. The error amplifier EA1 outputs an error voltage Vea1 in response to the difference between VR3 and Vref. On the other hand, comparator CMP1 output a pulse for resetting the flip-flop 35 when the ramp signal rises above the Vea1 level. So, a logic low signal from the output terminal of the flip-flop 35, via the level shifter 31, shuts down the power switch Q2 at T2.

At T2, both Q1 and Q2 shut down and the inductor current now flows into Vo2. The inductor current is decreased at a rate of (Vin−Vo2)/L1=−10V/L1. The inductor reaches zero at T3.

Briefly speaking, at T0, both Q1 and Q2 turn on. From T0 to T1, energy is delivered and accumulated in the inductor L1 and not delivered to Vo1 and Vo2 yet. At T1, Q1 turns off while Q2 remains on, so power begins to flow into Vo1 but not to Vo2 yet. When sufficient power is delivered to Vo1, Q2 turns off at T2. Now, power is delivered to Vo2 but not to Vo1. When all remaining power is delivered to Vo2 at T3, the inductor current reaches zero and no power is delivered to Vo1 and Vo2. From the above description, it is clear that Vea1 determines the conduction time of Q2, while Vea2 determines the conduction time of Q1.

The second switching cycle in FIG. 4A depicts the situation when Vo1 demands more power. This is achieved through higher Vea1 level and thus a longer Q2 conduction time. In the third switching cycle, Vo1 demands even more power by raising Vea1 level even higher. The boost converter now enters a continuous current mode to deliver more power to Vo1. Notice that in the continuous current mode, diode D2 has a shorter conduction time but the remaining inductor current is higher such that it maintains a same average output current to Vo2.

FIG. 4B shows the inductor current waveform when Vin drops to 4V, which is lower than Vo1 (5V). Between T1 (Q1 turns off) and T2 (Q2 turn off), the inductor current falls at a rate of (Vin-Vo1)/L1=(4V-5V)/L1. Again, as Vo1 demands more power, Vea1 increases, allowing more conduction time for Q2, thus delivering more power to Vo1.

FIG. 4C shows the inductor current waveform when Vin is 6.6V, which is higher than Vo1 (5V). Between, T1 (Q1 turns off) and T2 (Q2 turn off), the inductor current increases at a rate of (Vin−Vo1)/L1=(6.6V−5V)/L1. Again, as Vo1 demands more power, Vea1 increases, allowing more conduction time for Q2, thus delivering more power to Vo1

As described above, the converter delivers to all output voltages during a same switching cycle. And as long as there exists an output voltage higher than the input voltage, the converter has certain capability to step down Vin to Vo1, as shown in situation depicted by FIG. 4C, where Vin is 6.6V, and Vo1 is 5.0V.

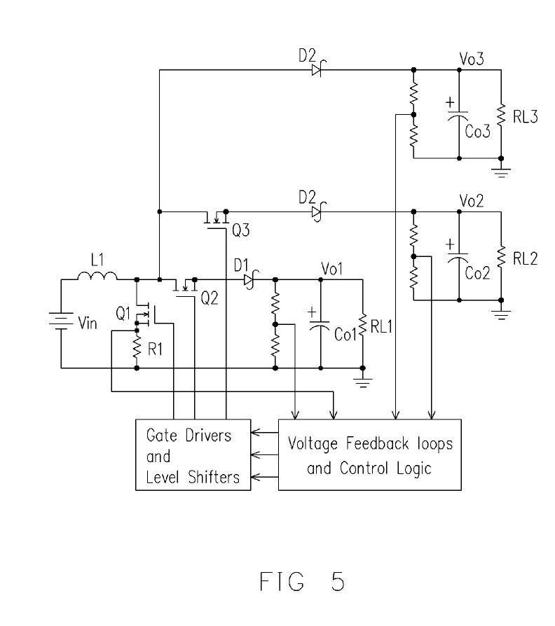

FIG. 5 illustrates a second embodiment of the present invention with an additional output voltage. The highest output voltage V03 has to be higher than the input voltage at all time. Vo3 does not require a serial power switch. Any other output voltage requires a high-side power switch in series with its output rectifier. The highest output voltage regulates the conduction time of the main power switch Q1. Any other output voltage regulates the conduction time of its own high-side power switch.

Each output voltage has a feedback loop and an error amplifier to create its own error voltage. The voltage feedback loop and control logic 51 also includes a bandgap reference voltage generator and an oscillator. The gate drivers and level shifters 52 include flip-flops for the main power switch and the high-side power switches and level shifters for the high-side power switches. The operation and inductor current waveforms of the DC-DC converter according to the second embodiment are similar to the first embodiment and the details thereof are omitted for simplicity.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A power converter using a single inductor for providing multiple power outputs at least including a first output and a second output, the second output being higher than both the first output and a power source, the power converter comprising:
a main power switch for regulating an inductor current;
a first switch for regulating the inductor current flowing to the first output;
a reference voltage;
a first control loop, generating a first error signal in response to the first output and the reference voltage;
a second control loop, generating a second error signal in response to the second output and the reference voltage; and
a control logic, for controlling the operation states of the main power switch and the first switch in response to the first and second error signals;
wherein the second output does not require a switch and the power converter delivers power to the first and second outputs during a same switching cycle.

2. The power converter of claim 1, further comprising a clock and reference wave generator for generating a clock signal and a reference wave.

3. The power converter of claim 1, wherein the first output regulates the conduction time of the first switch and the second output regulates the conduction time of the main power switch.

4. The power converter of claim 2, wherein the first control loop includes:
a first error amplifier, generating the first error signal in response to the reference voltage and a first fractional voltage from the first output;
a first comparator, comparing the first error signal and the reference wave for generating a first comparison result; and
a first flip-flop, receiving the clock signal and the first comparison result for gate driving the first switch.

5. The power converter of claim 2, wherein the second control loop includes:
a second error amplifier, generating the second error signal in response to the reference voltage and a second fractional voltage from the second output;
a second comparator, comparing the second error signal and a sense voltage from the main power switch for generating a second comparison result; and
a second flip-flop, receiving the clock signal and the second comparison result for gate driving the main power switch.

6. The power converter of claim 1, further comprising:
a first rectifier, serially connected between the first switch and the first output;
a first output capacitor, storing power for the first output, a first load being across the first output capacitor;
a second rectifier, serially connected between the main power switch and the second output; and
a second output capacitor, storing power for the second output, a second load being across the second output capacitor.

7. A method of charging a plurality of loads during the same switching cycle using a single inductor, comprising:
energizing the inductor;
sequentially delivering power to a first one of the loads and not to any other loads, and sequentially delivering power to a second one of the loads and not to any other loads; and
using a last-delivered load to reset the inductor current within the same switching cycle.

8. The method of claim 7, further includes a step of:
providing a main power switch and a load switch for each of the outputs except the last-delivered output.

9. The method of claim 8, wherein the step of sequentially delivering power includes:
conducting the main power switch and other load switches related to the loads except for the last-delivered load;
regulating the conduction time of the main power switch based on an output of the last-delivered load; and
regulating the conduction time of a load switch based on the output of the associated load of the said load switch;
wherein the last-delivered load does not require a switch.

10. The method of claim 7, wherein the output of the last-delivered load is higher than the power source and all other loads.

11. A voltage regulation system for providing output boost regulation for two loads in a switching cycle, the voltage regulation system comprising:
a power source;
an inductor, having a first terminal electrically connected to the power source and a second terminal;
a main power switch, having an input terminal electrically connected to the second terminal of the inductor, an output terminal and a gate terminal;
a first switch, having an input terminal electrically connected to the second terminal of the inductor, an output terminal and a gate terminal;
a first rectifier, having an anode terminal electrically connected to the output terminal of the first switch and a cathode terminal for connecting to the first load;
a second rectifier, having an anode terminal electrically connected to the second terminal of the inductor and a cathode terminal for connecting to the second load; and
voltage feedback loops and control logic, regulating the switching states of the main power switch and the first switch, based on voltages on the second load and the first load respectively, wherein the voltage on the second load, which resets the inductor current, does not require a switch.

12. The voltage regulation system of claim 11, further comprising:
a first output capacitor, coupled across the first load; and
a second output capacitor, couple across the second load.

13. The voltage regulation system of claim 11, wherein the voltage feedback loops and control logic includes:
a first error amplifier, generating a first error signal in response to a reference voltage and a first division voltage from the voltage on the first load;
a first comparator, comparing the first error signal and a reference wave for generating a first comparison result; and
a first flip-flop, receiving a clock signal and the first comparison result for gate driving the first switch.

14. The voltage regulation system of claim 13, wherein the voltage feedback loops and control logic further includes:
a second error amplifier, generating a second error signal in response to the reference voltage and a second division voltage from the voltage on the second load;
a second comparator, comparing the second error signal and a sense voltage from the main power switch for generating a second comparison result; and
a second flip-flop, receiving the clock signal and the second comparison result for gate driving the main power switch.
